(19) United States
(12) Patent Application Publication
(10) Pub. No.: US 2023/0180647 A1
(43) Pub. Date: Jun. 15, 2023

(54) AGRICULTURE IMPLEMENT AND MOUNTING ASSEMBLY

(71) Applicant: McFarlane Manufacturing Co., Sauk City, WI (US)

(72) Inventors: Jeffrey M. Marggi, Oregon, WI (US); George Angelo, Madison, WI (US); Aaron J. Faessler, Cross Plains, WI (US)

(73) Assignee: McFarlane Manufacturing Co., Sauk City, WI (US)

(21) Appl. No.: 17/550,764

(22) Filed: Dec. 14, 2021

(51) Int. Cl. A01B 61/04; A01B 5/04

(52) U.S. Cl. CPC A01B 61/046; A01B 5/04

(57) ABSTRACT

A machine includes a trailer frame, a tongue, a plurality of wheels, and an implement assembly. The tongue extends away from the trailer frame and supports a coupling. The plurality of wheels are coupled to the trailer frame. The implement assembly is coupled to the trailer frame, and includes a plurality of independent implement mounting assemblies coupled to a mounting rail. The independent implement mounting assemblies each include an arm, an implement, and a spring. The arm is selectively coupled to the mounting rail. The implement is coupled to a first end of the arm. The spring is coupled to a second end of the arm opposite the first end. The spring is configured to oppose movement of the implement relative to the mounting rail.

### BACKGROUND

Cultivators are a commonly-used type of agricultural implement that are designed to weed, root, and aerate topsoil both before and after the crop planting process has taken place. Cultivators can accomplish these tasks by disturbing topsoil using a variety of different implements, including sweeps, discs, and shanks. Cultivators traditionally struggle with changing topographies, soil conditions, and obstacles (e.g., rocks) within fields, as these obstructions have a tendency to lift and rotate the cultivator relative to the vehicle pulling the cultivator (e.g., a tractor). Rotation of the cultivator can result in tillage at varying depths, which can reduce the cultivator’s effectiveness.

### SUMMARY

One exemplary embodiment relates to a machine. The machine includes a trailer frame, a mounting assembly, a plurality of wheels, and an implement assembly. The tongue extends away from the trailer frame and supports a coupling. The plurality of wheels are coupled to the trailer frame. The implement assembly is coupled to the trailer frame, and includes a plurality of independent implement mounting assemblies coupled to a mounting rail. The independent implement mounting assemblies each include an arm, an implement, and a spring. The arm is selectively coupled to the mounting rail. The implement is coupled to a first end of the arm. The spring is coupled to a second end of the arm opposite the first end. The spring is configured to oppose movement of the implement relative to the mounting rail.

Another exemplary embodiment relates to an implement mounting assembly for use on a machine. The implement mounting assembly includes a pair of mounting plates, an arm, an implement, and a leaf spring. The arm is received between the pair of mounting plates and is selectively coupled to the pair of mounting plates. The implement is coupled to a first end of the arm, opposite the pair of mounting plates. The leaf spring is coupled to a second end of the arm opposite the first end. The leaf spring is configured to oppose movement of the implement relative to the pair of mounting plates.

Another exemplary embodiment relates to an implement assembly. The implement assembly includes a mounting rail and several independent implement mounting assemblies coupled to the mounting rail. Each of the independent implement mounting assemblies include at least one mounting plate, an arm, at least one implement, and a leaf spring. The arm is selectively coupled to the mounting plate. The at least one implement is coupled to a first end of the arm, opposite the mounting plate. The leaf spring is coupled to a second end of the arm opposite the first end. The leaf spring is configured to oppose movement of the implement relative to the mounting plate.

The invention is capable of other embodiments and of being carried out in various ways. Alternative exemplary embodiments relate to other features and combinations of features as may be recited herein.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a cultivator, according to an exemplary embodiment.

FIG. 2 is a detailed perspective view of a front portion of the cultivator of FIG. 1, depicting a first disc assembly.

FIG. 3 is a detailed perspective view of the rear portion of the cultivator of FIG. 1, detailing a second disc assembly.

FIG. 4 is a front perspective view of independent spring assemblies used to couple each disc from the disc assembly of FIG. 2 to the cultivator of FIG. 1.

FIG. 5 is another front perspective view of the independent spring assemblies of FIG. 4.

FIG. 6 is a perspective view of the disc assembly of FIG. 4, decoupled form the cultivator of FIG. 1.

FIG. 7 is a front perspective view of an individual independent spring assembly used to couple a disc from the disc assembly of FIG. 2 to the cultivator of FIG. 1.

FIG. 8 is a front view of the independent spring assembly of FIG. 7.

FIG. 9 is a rear view of the independent spring assembly of FIG. 7.

FIG. 10 is an exploded view of the independent spring assembly of FIG. 7.

FIG. 11 is a front perspective view of a coupling mechanism of the independent spring assembly of FIG. 7.

FIG. 12 is another detailed perspective view of the coupling mechanism of FIG. 10.

FIG. 13 is another detailed perspective view of the coupling mechanism of FIG. 10.

FIG. 14 is a perspective view of a leaf spring of the independent spring assembly of FIG. 7, shown in isolation.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the FIGURES generally, the various exemplary embodiments disclosed herein relate to systems, apparatuses, and methods for mounting an agriculture implement to a machine (e.g., a cultivator or tiller). The mounting systems provide an independent spring system that provides more consistent and resilient implement positioning to better handle obstructions within fields. The biasing force of the independent spring systems returns the attached implements to the desired heights quickly upon overcoming obstacles or obstructions in a field that might otherwise cause the machine supporting the implement to raise or lower, which in turn can raise or lower the implements relative to the ground, causing inconsistent, ineffective, and/or potentially damaging engagement with the topsoil. The mounting systems also provide increased durability relative to conventional systems, while also providing connections that allow implements attached to the machine to be readily replaceable.

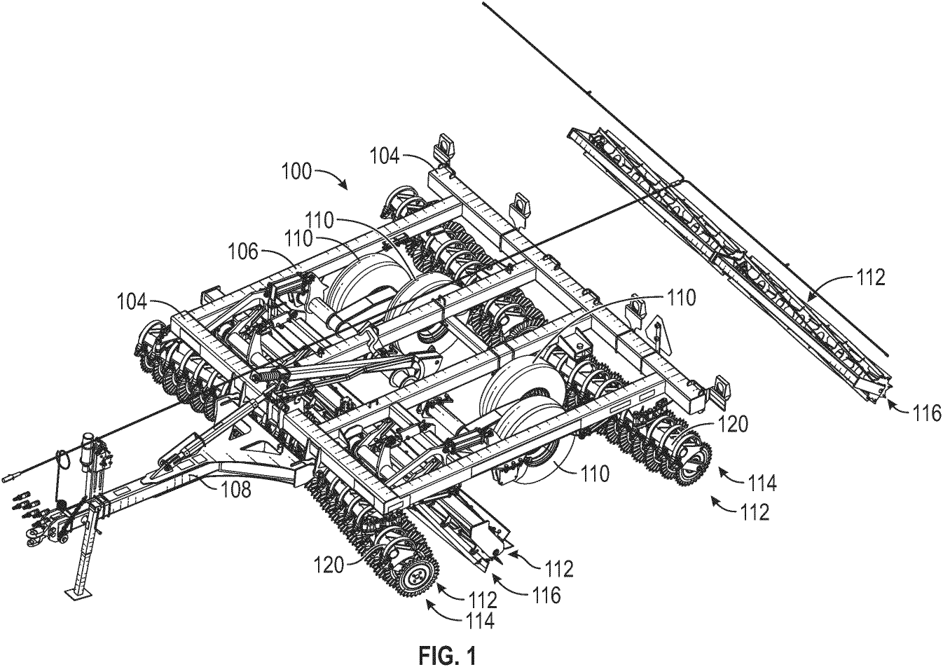

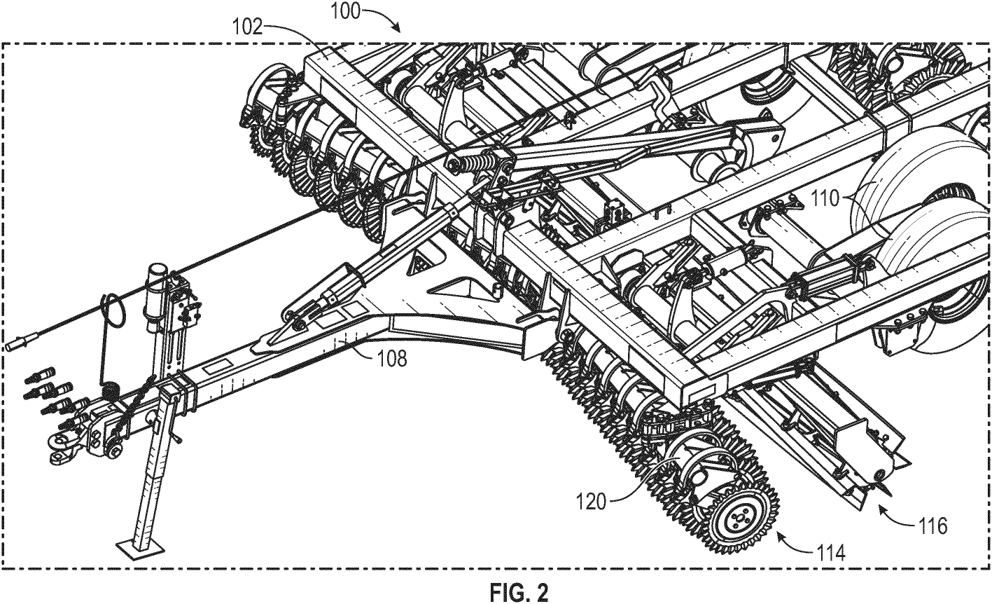

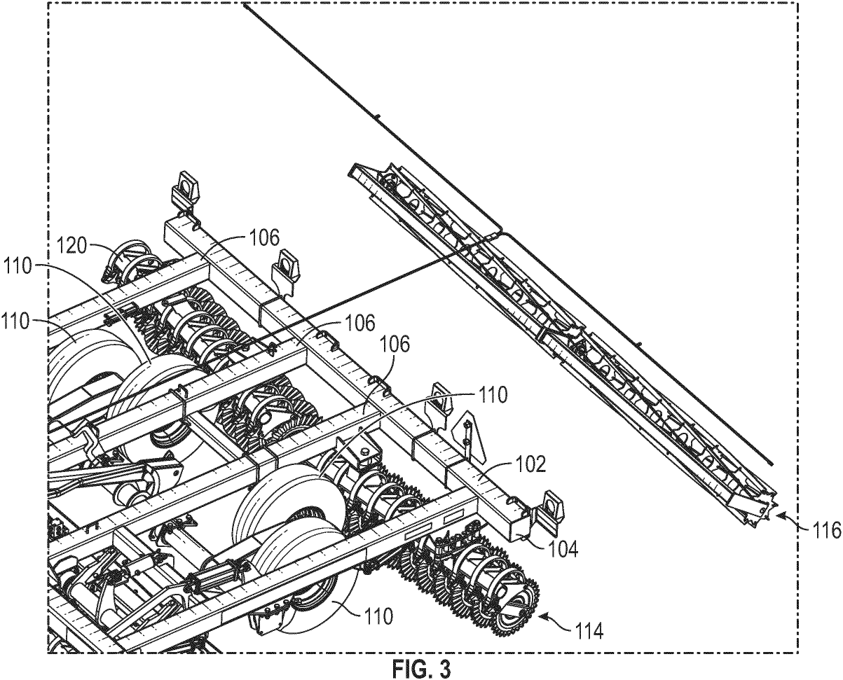

Referring now to FIG. 1, a machine 100 is depicted. The machine can be a cultivator or tiller, for example, that is configured to be towed by a tractor or other agriculture vehicle (not shown). The machine 100 generally includes a rectangular metallic trailer frame 102 formed by cross members 104 and beams 106 that are rigidly coupled (e.g., welded) together. A mounting assembly, shown as tongue 108 extends forward from the trailer frame 102 to receive a hitch to permit selective coupling between the machine 100 and a tractor or other agriculture vehicle. Although depicted as a tongue 108, various other types of couplings can be used as the mounting assembly to create a mechanical connection between the machine 100 and a tractor or agriculture vehicle. For example, a three-point mounting system can be included in place of the tongue and hitch mechanism. As depicted in FIG. 1, the machine 100 includes a plurality of wheels 110 that are coupled to the trailer frame 102. The wheels 110 are rotatable between a deployed position (not shown) and a stowed position shown in FIG. 1. In the deployed position, the wheels 110 are configured to extend below each of the implements 112 supported by the trailer frame 102 so that the weight of the machine 100 is supported by the wheels 110. With the wheels 110 deployed, the machine 100 can be readily transported without any implements 112 contacting the ground, which allows transit over roadways and other hardened surfaces. Once the wheels 110 are retracted to the stowed position, the implements 112 extend downwardly below the wheels, such that the weight of the trailer is then supported by the implements 112. In some examples, the wheels 110 are configured to be moved between the deployed position and the stowed position hydraulically.

The trailer frame 102 supports one or more implements 112. The implements 112 can include a variety of different agricultural tools including disc assemblies 114, rolling baskets 116, and the like to agitate and cultivate topsoil while cutting and sizing weeds, roots, soil clods, and other items that might otherwise inhibit crop growth. As depicted in FIG. 1, the implements can be arranged in series so that multiple implements 112 (including multiple styles of implements) will interact with the topsoil as the machine 100 performs a single pass. As depicted, the machine 100 includes two disc assemblies 114 and two separate rolling baskets 116 each arranged immediately behind one of the sets of discs 114. By positioning the rolling baskets 116 behind the disc assemblies 114, the rolling baskets 116 are in a position to handle and break apart soil clods and other debris that may be kicked up from the topsoil by the disc assemblies 114 as they pass through the topsoil. By including multiple sets of implements 112, redundancy can be built into the machine 100 to ensure that adequate soil agitation is achieved in a single pass. In some examples, the trailer frame 102 supports one or more hydraulic cylinders that are configured to adjust a position of the disc assemblies 114 and/or rolling baskets 116 relative to the trailer frame 102. The position can be adjusted by rotating the entire disc assembly forward or rearward, which adjusts an angle of the implements 112 relative to the ground, which can in turn adjust a depth of the cultivating process.

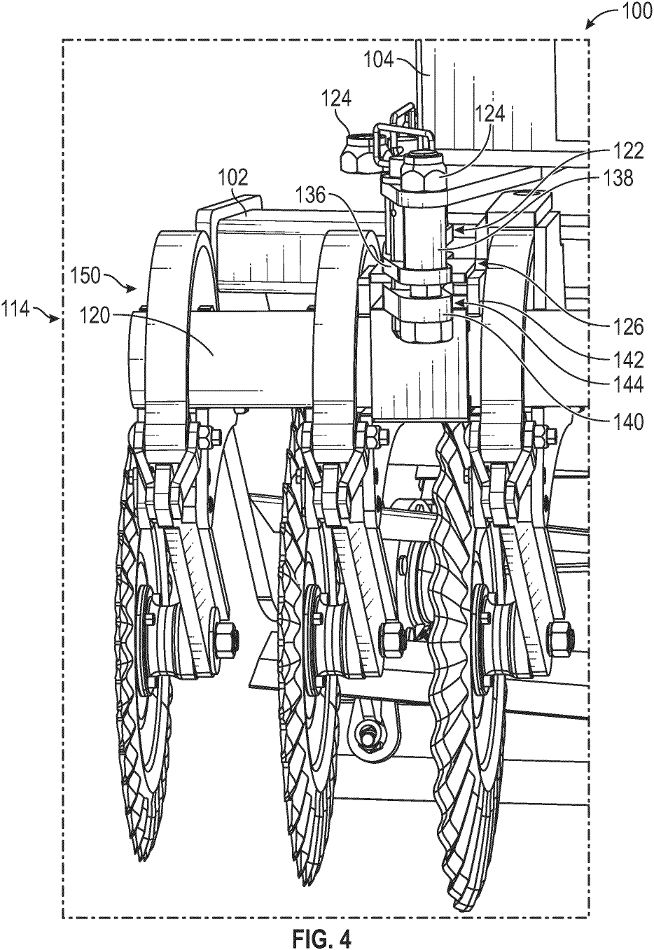

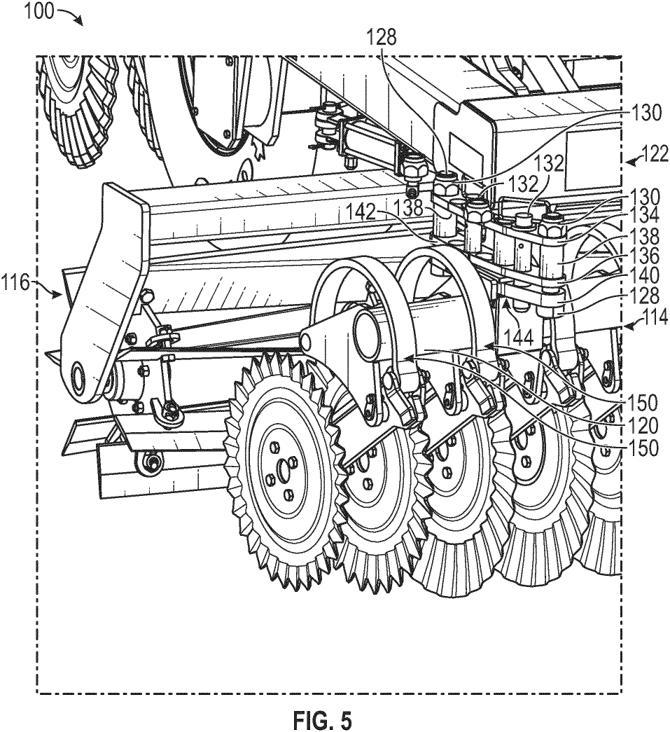

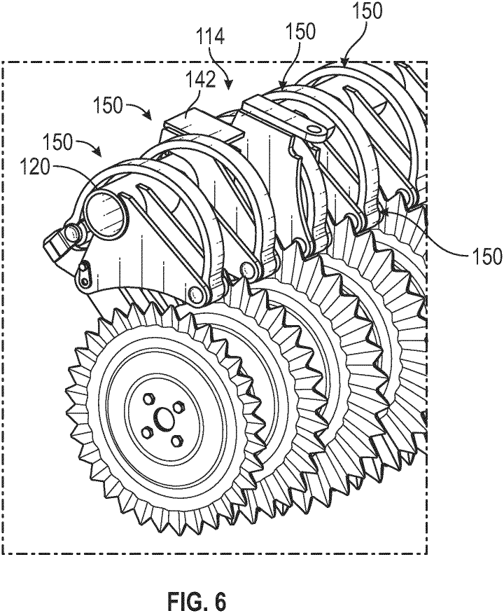

With additional reference now to FIGS. 4-6, a disc assembly 114 from the machine 100 is shown in additional detail. The disc assembly 114 generally includes a mounting tube or rail 120 that is suspended from and clamped to the trailer frame 102 by one or more brackets 122. The brackets 122 can be mounted to one of the cross members 104 or beams 106, and can include a series of fasteners 124 that are configured to create a removable coupling between the mounting rail 120 and the trailer frame 102. For example, and as depicted in FIG. 5, the brackets 122 include a series of plates 126 that are coupled together using a combination of bolts 128, nuts 130, and quick-release pins 132. A top plate 134 of the bracket 122 can be rigidly coupled to the trailer frame 102 (e.g., welded, brazed, formed integrally with, etc.), and extends outward from the trailer frame 102. A second, or middle plate 136 is coupled to the top plate 134 using a series of spacers 138 received within and coupled to holes formed within each of the top plate 134 and middle plate 136. In some examples, the spacers 138 are rigidly coupled (e.g., welded, etc.) or otherwise secured to each of the top plate 134 and middle plate 136.

The disc assembly 114 can be mounted to the brackets 122 using a third or bottom plate 140. The bottom plate 140 can extend through a channel 142 formed upon the mounting rail 120. The channel 142 is formed from plate steel, for example, and defines a pocket 144 that can receive the bottom plate 140. With the bottom plate 140 positioned within the pocket 144, the bolts 128 and nuts 130 can be tightened so that a clamping force is generated between the middle plate 136 and the bottom plate 140. The clamping force is applied to a top surface 146 of the channel 142, which then secures the channel 142 within the bracket 122. The quick-release pins 132 can provide further securement and can help limit rotational movement of the mounting rail 120 relative to the trailer frame 102. The use of fasteners 124 and quick-release pins 132 creates a removable coupling between the trailer frame 102 and the disc assembly 114 that can allow for complete removal of the disc assembly 114, which can be useful for a variety of reasons. For example, the removable coupling can allow the disc assembly 114 to be replaced with another implement 112 to perform a different task. The removable coupling also allows an operator to more easily access components of the disc assembly 114 for maintenance purposes.

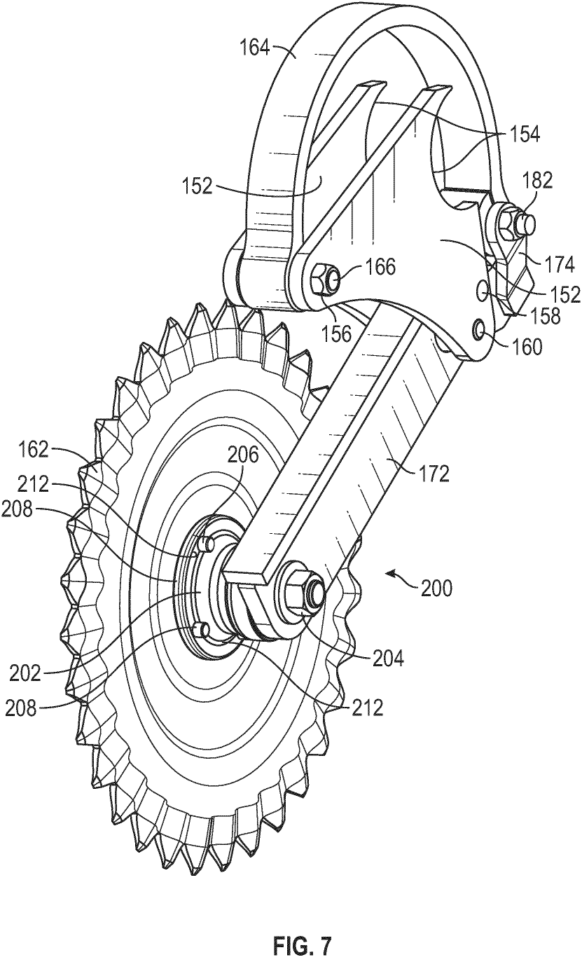

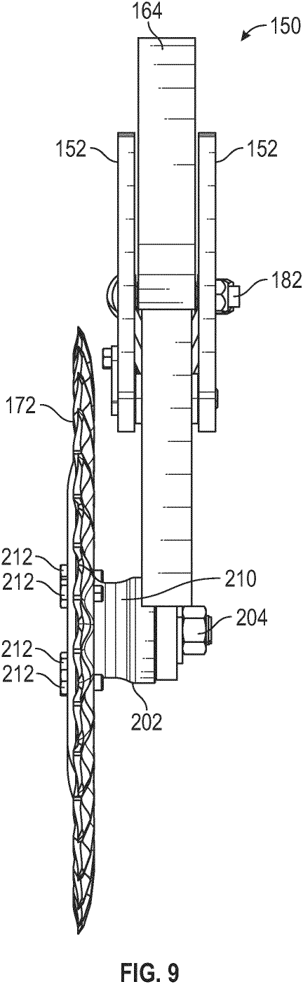

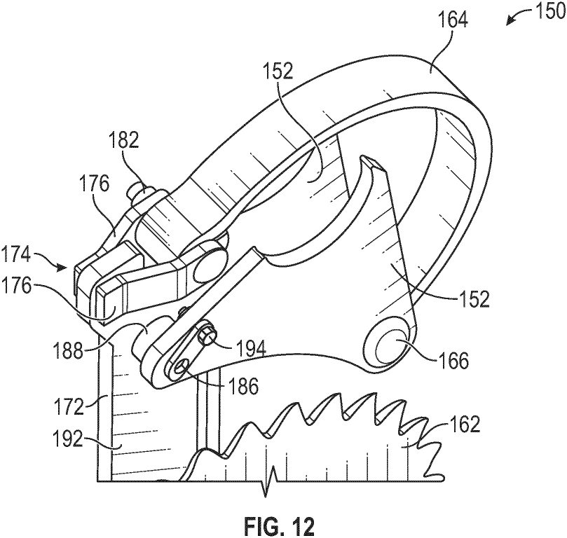

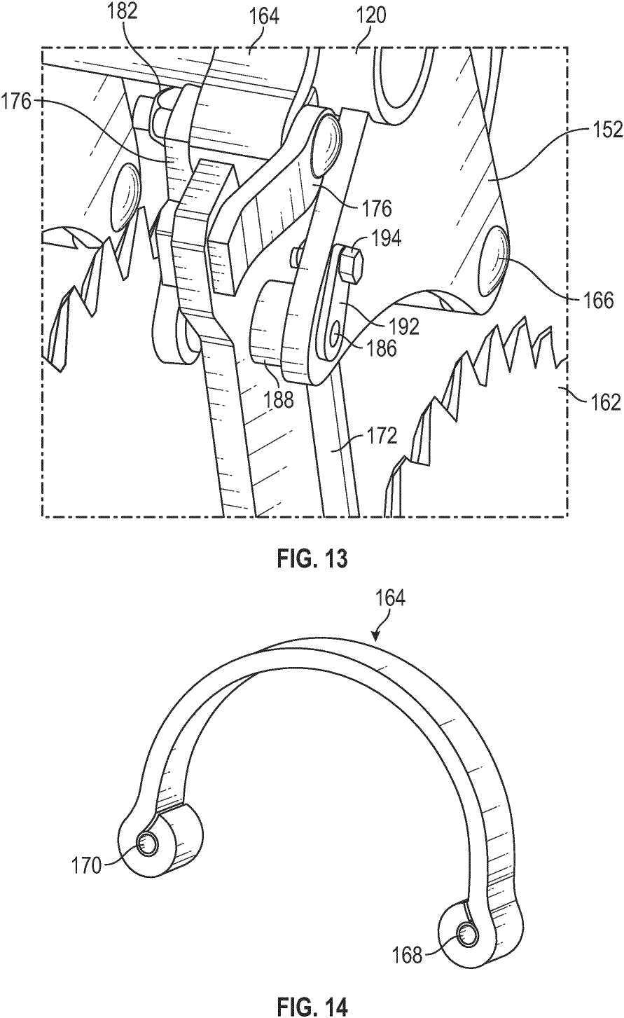

With additional reference to FIGS. 7-13, the disc assembly 114 includes a series of independent implement mounting assemblies 150 spaced about the mounting rail 120. The independent implement mounting assemblies 150 can be secured to the mounting rail 120 using one or more cam-shaped mounting plates 152. As depicted in FIG. 7, each of the mounting plates 152 are arranged in pairs and have a generally triangular outer perimeter. Semi-circular cutouts 154 are formed within each of the mounting plates 152. The semi-circular cutouts 154 are formed with a radius approximately equal to a radius defining the mounting rail 120, such that the mounting plates 152 can be readily positioned on the mounting rail 120. In some examples, the mounting plates 152 are rigidly coupled to the mounting rail 120. For example, each of the mounting plates 152 can be welded to the mounting rail 120.

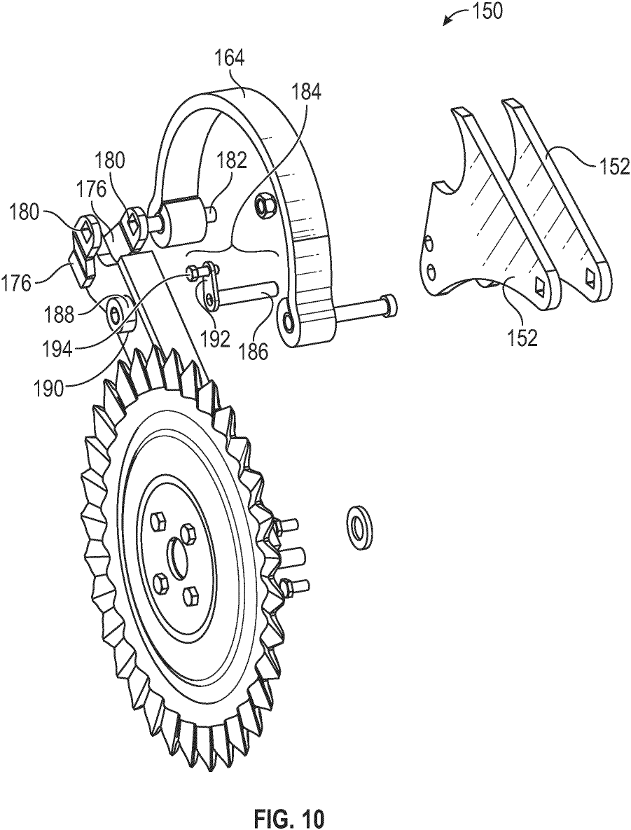

The mounting plates 152 define a series of holes 156, 158, 160 to receive and secure an implement (e.g., a disk, tiller, plow, aerator, etc.), shown as the disc 162, to the mounting rail 120. For example, and as depicted in FIG. 10, each of the mounting plates 152 include a first hole 156 positioned near a front of each mounting plate 152. The first hole 156 is configured to receive and support a first end of a spring, shown as a leaf spring 164. The leaf spring 164 is secured to the mounting plates 152 using a fastener 166 (e.g., a nut and bolt, etc.). The bolt of the fastener 166 can extend through the first hole 156 of a first mounting plate 152, through a cylindrical passage 168 formed within a first end of the leaf spring 164, and through the first hole 156 of a second mounting plate 152 to couple the leaf spring 164 to the independent implement mounting assembly 150. The nut of the fastener 166 can then be threaded into engagement with the bolt to create a secure yet releasable coupling between the leaf spring 164 and the independent implement mounting assembly 150. Two additional holes 158, 160 can be formed in a rear side of the mounting plates 152 to help further reinforce the coupling between the implement 162 and mounting assembly 150, as explained in additional detail below.

The leaf spring 164, shown in isolation in FIG. 14, is defined by a generally curved and semi-circular shape. In some examples, the generally curved shape of the leaf spring 164 is defined by a constant or near-constant radius. Alternatively, a variable-radius shape can be used. The arc of the semi-circular shape extends approximately (e.g., +/- 20 degrees) 180 degrees. The curvature of the leaf spring 164 provides a natural spring force that opposes both tensile and compressive forces. Accordingly, the leaf spring 164 can bias the implement 162 downward, and can oppose forces experienced by the implement 162 in either direction. The leaf spring 164 can be formed from a mild steel, for example. Like the first end, the second end of the leaf spring 164 also includes a cylindrical passage 170 to receive a fastener. In some examples, the first end and second end of the leaf spring 164 are formed approximately identically, such that the leaf spring 164 can be installed in either orientation without sacrificing performance.

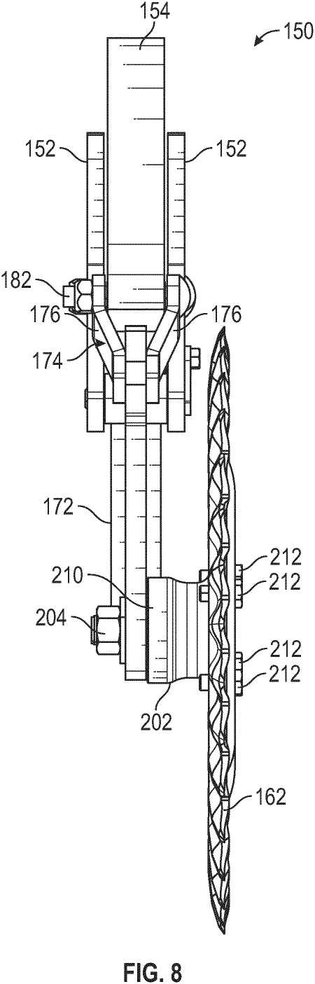

The second end of the leaf spring 164 is secured to an arm 172 using a clevis 174. The clevis 174 is rigidly coupled to the arm 172 at a first end and cantilevers away from arm 172 at a second end. As depicted in FIG. 8, the clevis 174 is formed from two wings 176 that each extend forwardly and outwardly away from the arm 172. A hole 180 is formed within each wing 176 to receive a fastener 182. The fastener 182 secures the leaf spring 164 to the arm 172 by extending through the hole 180 formed within the first wing 176, through the cylindrical passage 170 formed within the second end of the leaf spring 164, and through the hole 180 formed within the second wing 176. Like the fastener 166, the fastener 182 can be a nut and bolt arrangement that creates a threaded and removable coupling to secure the leaf spring 164 to the arm 172.

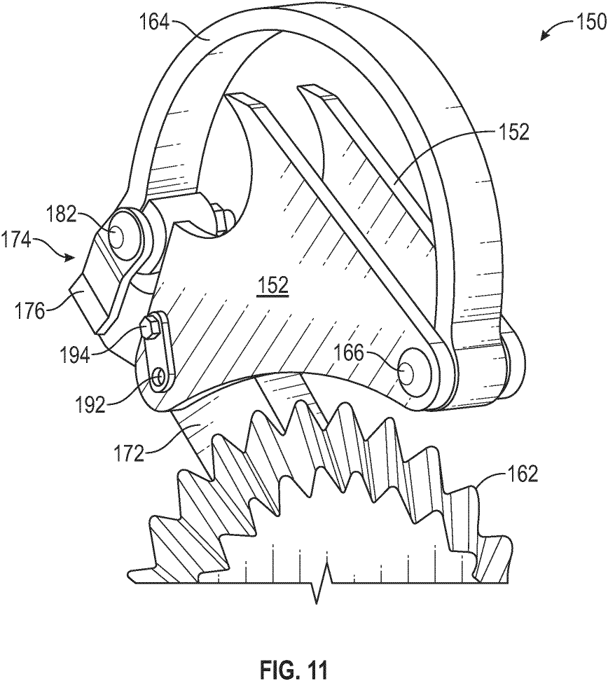

The arm 172 is also coupled to the mounting plates 152 to help position the leaf spring 164 relative to the mounting rail 120. As depicted in FIG. 11, one or more fasteners 184 can be used to secure an upper portion of the arm 172 to the mounting plates 152. In some examples, and as depicted in FIGS. 10-13, the fasteners 184 include a bolt and bushing assembly. The bolt 186 can extend into and be received within a nylon bushing 188, and can be used to control the position of the arm 172 relative to the mounting plates 152. The bushing is positioned between two adjacent mounting plates 152, and is held into position by the bolt 186. The bushing is aligned with the holes 160, and extends from a first mounting plate 152 through a central passage 190 formed within the arm 172, and to the second mounting plate 152. The bolt 186 can extend through the hole 160, into the bushing 188, and through the hole 160 formed in the opposite mounting plate 152. In some examples, the bolt 186 is secured to the second mounting plate via an interference or press fit with the hole 160. In other examples, the bolt 186 can be threaded, and can receive a nut (not shown) that together secures the bolt 186 and bushing 188 in place relative to the mounting plates 152. The bushing 188 is arranged to both support the arm 172 positioning relative to the mounting plates 152 and absorb impacts that might be imparted on the implement 162 and transmitted through to the arm 172.

The bolt and bushing assembly can also be secured into place using a separate tab 192 and fastener 194 (e.g., a bolt and nut) that extend through the hole 158 formed within the mounting plates 152. The tab 192 can be rigidly secured to the bolt 186, such that securing the tab 192 to the mounting plate 152 using the fastener 194 serves to secure the bolt and bushing assembly into position relative to the mounting plate 152 as well. Using the tab 192 and fastener 194, a removable coupling is created between the arm 172 and the mounting plates 152, and between the arm 172 and the independent implement mounting system 150, more generally. This removable coupling between the arm 172 and the mounting plates 152 can allow a user to readily exchange worn or damaged components, which improves the maintainability of the overall machine 100.

The multiple-point coupling formed by the leaf spring 164, the clevis 174, the mounting plates 152, and the bolt 186 and bushing 188 creates a structure that biases the arm 172 (and attached implement 162) downward, toward the ground below, yet allows the arm 172 to rotate upwardly (e.g., rearwardly) relative to and about an axis defined by the mounting rail 120 if the implement 162 encounters an obstacle. Despite this allowable range of motion, the spring force and generally rigid structure of the leaf spring 164 restricts the arm 172 from twisting motion that may otherwise occur in traditional systems. Further, the leaf spring 164 is designed such that a nearly uniform spring force is applied to the arm 172 regardless of its positioning and deflection. While traditional torsion cord assemblies are prone to snapping and failure, the structure of the leaf spring 164 of the independent implement mounting system 150 provides a near constant force as it deflects relative to the mounting rail 120, resulting in a far more robust mounting system.

The independent implement mounting systems 150 also provide each implement 162 with a separate connection, which creates a number of distinct advantages over traditional systems. First and foremost, the independent implement mounting system allows each implement 162 to move and rotate independently of one another about the mounting rail 120. As obstacles may only impact one single implement 162, providing independent mounting systems for each implement 162 prevents a small obstacle from interfering with the ground engagement of other implements 162 mounted to the mounting rail. Conventional cultivators include two or more implements mounted to a single support structure on a disc assembly, which could at times amplify that damage and/or displacement caused by encountering an obstacle. For example, a large rock or root could cause the entire cultivator to lift out of the ground, rotating and in extreme cases even overturning the entire machine. Similarly, the rotation could cause damage to the coupling between the trailer frame and the tractor. The independent nature of each implement mounting system 150 is such that only the implements 162 directly interacting or encountering the obstacle within the topsoil will be impacted, keeping the other implements 162 within the disc assembly 114 appropriately engaged with the ground. Damaging twisting motion is avoided to each of the trailer frame and the tractor.

The structure of the independent mounting systems 150 also provides additional advantages over conventional systems. For example, the independent and removable nature of each independent implement mounting system 150 is such that individual components can be readily replaced and maintained. For example, any combination of the arm 172, bolt 186 and bushing 188, and implement 162 can be readily replaced without performing a full overhaul of the machine 100. While traditional cultivators often include rigidly mounted implements that require full-scale replacement in the event of individual component failure, the independent mounting systems 150 allow replacement on an individualized level, reducing the cost of maintenance substantially.

The narrow frame of the independent mounting systems 150 also increases the number of implements 162 that can be mounted to a single disc assembly 114. The robust nature of the leaf spring 162 and the additional mounting features permits a large number of independent mounting systems 150 to be placed on a single mounting rail 120. Reduced spacing can provide increased productivity in tilling and cultivating. Additionally, the shape of the leaf spring 164 is such that the leaf spring 164 can help obstruct dirt and other debris passing rearward, toward the bolt 186 and bushing 188 and toward the clevis 174. Accordingly, less build up will occur over time, which can again reduce the frequency in which maintenance needs to be performed to keep the machine 100 operating at or near full capacity.

The independent mounting system 150 is configured to support a variety of different implements, including the disc 162. As depicted in FIGS. 7-10, the arm 172 includes an implement attachment assembly 200 positioned at an end of the arm 172 opposite the clevis 174 and opposite the leaf spring 164. In some examples, the implement attachment assembly 200 is a hub 202. The hub 202 can be a sealed hub, for example, which is mounted to the arm 172 using a hub fastener 204. The hub fastener 204 can include a bolt, nut, and washer, for example, that thread into an internal shaft of the hub 202. The hub includes a plurality of threaded holes 206 spaced about a flange 208 formed on an outer body 210 of the hub 202. The threaded holes 206 can be spaced apart evenly about the flange 208. In some examples, and as depicted in the FIGS. 7-10, each hub 202 includes four threaded holes 206 that are configured to receive male threaded bolts 212 to mount the implement 162 to the hub 202. The outer body 210 of the hub 202 is configured to rotate about the internal shaft of the hub 202. One or more bearings (not shown) can be received around the internal shaft of the hub 202 to permit rotation of the hub 202 and associated implement 162 relative to the arm 172.

Although shown as a disc 162, a variety of different implements can be readily coupled to the arm 172 to create multiple uses for the machine 100. For example, the hub 202 can be decoupled from the arm 172 and replaced with another implement that is fastened or otherwise secured into position on a distal end of the arm 172. In some embodiments, a plow or tiller can be coupled to the arm 172 in place of the disc 162. In some examples, the tiller is a rotary tiller that can be coupled to the hub 202. Various other types of implements can be mounted to the arm 172 as well. Additionally or alternatively, multiple arms 172 can be configured to support a single implement that spans across multiple independent mounting systems 150. For example, rakes spanning multiple implement mounting assemblies 150 can be coupled to a plurality of the arms 172.

Using the foregoing independent implement mounting system 150, a more resilient and reliable machine 100 can be created. The independent mounting and structural rigidity of the leaf spring is such that obstacles encountered by the machine 100 are far less damaging and have a significantly lower impact on the effectiveness of the machine 100 than traditional systems. The machines 100 are much more easily maintained, and can be customized to perform specific jobs during different parts of the growing season.

Although this description may discuss a specific order of method steps, the order of the steps may differ from what is outlined. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the agricultural implement as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A machine comprising:
a trailer frame;
a mounting assembly extending away from the trailer frame and supporting a coupling;
a plurality of wheels coupled to the trailer frame; and
an implement assembly coupled to the trailer frame, wherein the implement assembly includes a plurality of independent implement mounting assemblies coupled to a mounting rail, the independent implement mounting assemblies each comprising:
an arm selectively coupled to the mounting rail;
an implement coupled to a first end of the arm; and
a spring coupled to a second end of the arm opposite the first end, wherein the spring is configured to oppose movement of the implement relative to the mounting rail.

2. The machine of claim 1, wherein the independent implement mounting assemblies further comprise a mounting plate coupled to the mounting rail, wherein a first end of the spring is coupled to the mounting plate and wherein a second end of the spring is coupled to the second end of the arm.

3. The machine of claim 2, wherein the mounting plate is a first mounting plate, and wherein the independent implement mounting assemblies further comprise a second mounting plate extending approximately parallel to the first mounting plate, wherein the first end of the spring is removably coupled to the first mounting plate and the second mounting plate using a fastener extending through each of the first mounting plate and the second mounting plate.

4. The machine of claim 3, wherein the second end of the spring is removably coupled the arm using a clevis.

5. The machine of claim 4, wherein the clevis includes a first wing and a second wing, wherein the first wing is rigidly coupled to a first side of the arm and wherein the second wing is rigidly coupled to a second side of the arm.

6. The machine of claim 3, wherein the arm is removably coupled to the first mounting plate and the second mounting plate using a fastener assembly, wherein the fastener assembly includes a bushing extending between the first mounting plate, through a passage within the arm, toward the second mounting plate.

7. The machine of claim 6, wherein the bushing is secured to the first mounting plate and the second mounting plate using a second fastener, wherein the second fastener extends at least partially through the bushing.

8. The machine of claim 7, wherein the second fastener is coupled to the first mounting plate using a tab, wherein the tab is fastened to the first mounting plate using a third fastener, wherein the second fastener and the third fastener extend along parallel axes.

9. The machine of claim 7, wherein the bushing is formed from nylon.

10. The machine of claim 2, wherein the implement is a disc.

11. The machine of claim 2, wherein the spring is a leaf spring.

12. An implement mounting assembly for use on a machine, the implement mounting assembly comprising:
a pair of mounting plates;
an arm received between the pair of mounting plates and selectively coupled to the pair of mounting plates;
an implement coupled to a first end of the arm, opposite the pair of mounting plates; and
a leaf spring coupled to a second end of the arm opposite the first end, wherein the leaf spring is configured to oppose movement of the implement relative to the pair of mounting plates.

13. The implement mounting assembly of claim 12, wherein the pair of mounting plates each include a semicircular cutout to receive a mounting rail.

14. The implement mounting assembly of claim 12, wherein a first end of the leaf spring is coupled to the pair of mounting plates using a fastener, and wherein a second end of the leaf spring is coupled to the second end of the arm using a clevis.

15. The implement mounting assembly of claim 14, wherein the clevis includes a first wing and a second wing, wherein the first wing is welded to a first side of the arm and wherein the second wing is welded to a second side of the arm.

16. The implement mounting assembly of claim 15, wherein the pair of mounting plates includes a first mounting plate and a second mounting plate, and wherein the arm is removably coupled to the first mounting plate and the second mounting plate using a fastener assembly, wherein the fastener assembly includes a bushing extending between the first mounting plate, through a passage within the arm, toward the second mounting plate.

17. The implement mounting assembly of claim 16, further comprising a hub removably coupled to the first end of the arm, wherein the hub is coupled to the implement and configured to facilitate rotary motion of the implement relative to the arm.

18. An implement assembly, comprising:
a mounting rail; and
a plurality of independent implement mounting assemblies coupled to the mounting rail, each of the independent implement mounting assemblies comprising:
a mounting plate;
an arm selectively coupled to the mounting plate;
an implement coupled to a first end of the arm, opposite the mounting plate; and
a leaf spring coupled to a second end of the arm opposite the first end, wherein the leaf spring is configured to oppose movement of the implement relative to the mounting plate.

19. The implement assembly of claim 18, wherein each of the arm and implement are removably coupled to the mounting plate.

20. The implement assembly of claim 18, wherein a first end of the leaf spring is coupled to the mounting plate using a fastener, and wherein a second end of the leaf spring is coupled to the second end of the arm using a clevis.
